(19) United States
(12) Patent Application Publication
(10) Pub. No.: US 2007/0172644 A1
(43) Pub. Date: Jul. 26, 2007

(54) Pearl-like decorative paper having suitability for postforming and thermosetting resin decorative sheet

(76) Inventors: Kazuhiro Hama, Tokyo-to (JP); Takashi Iizuka, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 10/570,753

(22) PCT Filed: Sep. 10, 2004
(86) PCT No.: PCT/JP04/13249

§ 371 Date: Sep. 15, 2006

(30) Foreign Application Priority Data
Sep. 12, 2003 (JP) 2003-321034

(51) Int. Cl. B32B 5/16; B32B 15/02

(52) U.S. Cl. 428/324; 428/404; 428/329; 428/331

(57) ABSTRACT

A pearl-like decorative paper and a thermosetting resin decorative sheet having postforming suitability with no blisters or cracking generation by the postforming process even in the case of the pearl-like design are provided. In the pearl-like decorative paper 10 having a pearl ink layer 3 containing a pearl pigment on a paper substrate 1, a pearl pigment of a scaly foil of mica covered with a titanium dioxide and/or an iron oxide, and the surface thereof further treated with a zirconium oxide hydrate is used as the pearl pigment. By providing a pattern ink layer 2 of an ordinary ink therebetween, a further better design can be provided. Then, by impregnating the pearl-like decorative paper with a thermosetting resin such as a melamine resin, laminating the same with an adherend 6 such as a backing substrate 4 and an overlaying paper 5, and applying thermal pressing molding for curing the resin, a pearl-like thermosetting resin decorative sheet 20 including a pearl-like decorative paper 10A with the resin cured can be provided.

### TECHNICAL FIELD

The present invention relates to a pearl-like decorative paper and a thermosetting resin decorative sheet having postforming suitability, to be used for various kinds of building material applications such as top boards for a desk, a table, a counter, or the like, building interior materials such as furniture, a wall and a floor, or the like.

### BACKGROUND ART

A thermosetting resin decorative sheet represented by a melamine decorative sheet is produced in general by impregnating a decorative paper with a pattern printed on a paper substrate with a thermosetting resin such as a melamine resin, and adding thermal pressure to the same together with an adherend such as a backing substrate and an overlaying paper so as to be cured, laminated and integrated. As a design expression for the above-mentioned decorative sheet or decorative paper, a pearl-like design can be presented. For such a pearl-like decorative paper or thermosetting resin decorative sheet, it is known that a pearl ink with a pearl pigment such as mica added is used for printing a pattern of the decorative paper (see the Japanese Utility Model Application Publication No. 52-55514 and the Japanese Patent Application Laid-Open (JP-A) No. 53-56268, or the like).

Moreover, by further applying a postforming process of bending the thermosetting resin decorative sheet with heat, and attaching the same continuously to another substrate such as a woody sheet from its top surface to the end surface, a postformed product can be obtained. Such a product is also a thermosetting resin decorative sheet. In particular, a postformed product of a melamine decorative sheet is representative. However, at the time of the postforming process, the followings may occasionally occur: a cracking generated when the heating is weak, a blister generated when the heating is strong. Consequently, a decorative paper or the like having postforming suitability improved by devising the contents of the paper substrate to avoid generation of blisters and cracking is proposed (JP-A No. 6-136682).

However, in the postformed product, when obtaining a pearl-like design, blisters can easily be generated at the time of the postforming process compared with the case of an ordinary design. As mentioned in JP-A No. 6-136682, even if the paper substrate is devised, no improvement was observed for the blister generation. Moreover, lowering the heating temperature to restrain the blister generation at the time of the process results in easily generating of cracks. Accordingly, in the case of the pearl-like design, a problem is involved in that a product can hardly be provided due to the poor postforming suitability.

### DISCLOSURE OF THE INVENTION

### Problem to be Solved by the Invention

That is, an object of the present invention is to provide a pearl-like decorative paper and a thermosetting resin decorative sheet having postforming suitability, without generating blisters or cracking by the postforming process even in the case of the pearl-like design.

### Means for Solving the Problem

In order to solve the above-mentioned problem, a pearl-like decorative paper having postforming suitability of the present invention has a configuration of comprising a pearl ink layer with a pearl pigment contained on a paper substrate, wherein the pearl pigment is a pearl pigment of a scaly foil of mica covered with a titanium dioxide and/or an iron oxide, and a surface thereof is further treated with a zirconium oxide hydrate.

Such configuration allows obtaining, even in the case of a pearl-like design, the postforming suitability of hardly generating blisters or cracking by the heat or the stress at the time of the postforming process of heating and bending a thermosetting resin decorative sheet produced by using the decorative paper. This is probably because of the improvement of the adhesion property with the binder resin of the pearl pigment.

Moreover, a pearl-like thermosetting resin decorative sheet having postforming suitability of the present invention has a configuration of comprising a layer obtained by impregnating the above-mentioned pearl-like decorative paper with a thermosetting resin and curing.

Such configuration enables to achieve, at the time of producing the pearl-like thermosetting resin decorative sheet, the effects described for the above-mentioned pearl-like decorative paper. That is, even in the case of a pearl-like design, a decorative sheet capable of avoiding blisters or cracking derived from the postforming process can be obtained probably owing to the improvement of the adhesion property with the binder resin of the pearl pigment.

### EFFECT OF THE INVENTION

(1) According to the pearl-like decorative paper of the present invention, despite its pearl-like design, the postforming suitability capable of restraining generation of blisters or cracking at the time of the postforming process of a pearl-like thermosetting resin decorative sheet produced by using the decorative paper can be obtained.

(2) Moreover, according to the pearl-like thermosetting resin decorative sheet of the present invention, quality deterioration due to blister generation or cracking generation derived from the postforming process can be avoided.

### BEST MODE FOR CARRYING OUT THE INVENTION

Hereinafter, embodiments of the present invention will be explained with reference to the drawings.

§1. Summary:

First, FIGS. 1(A) to 1(B) are cross-sectional views each showing one embodiment of a pearl-like decorative paper 10 (FIG. 1(A)) and a pearl-like thermosetting resin decorative sheet 20 (FIG. 1(B)) having postforming suitability of the present invention.

The pearl-like decorative paper 10 shown in FIG. 1(A) is a decorative paper having a configuration of: a pattern ink layer 2 (by an ordinary ink with no pearl pigment contained); a pearl ink layer 3 containing a specific pearl pigment comprising the scaly foil of mica covered with a titanium dioxide and/or an iron oxide, and the surface thereof is further treated with a zirconium oxide hydrate as the pearl pigment; and the layers 2 and 3 are formed in this order by printing, or the like on a paper substrate 1. Although the pattern ink layer 2 under the pearl ink layer 3 may be omitted depending on the design, it is in general provided for providing a better design.

Such a pearl-like decorative paper 10 can be used preferably for a thermosetting resin decorative sheet, representatively a melamine decorative paper. Furthermore, the paper 10 can be used preferably for the post forming application. Consequently, a pearl-like thermosetting resin decorative sheet 20 as shown for example in FIG. 1(B) can be obtained.

That is, the pearl-like thermosetting resin decorative sheet 20 with a cross-sectional view of its embodiment shown in FIG. 1(B) is a decorative sheet having the following configuration; a pearl-like decorative paper 10A, prepared by impregnating the above-mentioned pearl-like decorative paper 10 with a thermosetting resin and curing, has a backing substrate 4 provided on its rear side and an overlaying paper 5 provided on its front side so as to be laminated and integrated such that it is sandwiched on the front and rear sides by adherends 6 comprising the backing substrate 4 and the overlaying paper 5. The backing substrate 4 is representatively a core paper.

The pearl-like decorative paper and pearl-like thermosetting resin decorative sheet of the above-mentioned configurations, even in the case a pearl-like design is included, can provide the postforming suitability capable of improving generation of the blisters or the cracking at the time of the postforming process.

§2. Pearl-Like Decorative Paper:

Next, a pearl-like decorative paper having postforming suitability of the present invention will be explained. The pearl-like decorative paper of the present invention is characterized in having postforming suitability capable of improving generation of blisters and cracking by use of a specific pearl pigment as the pearl pigment for the pearl ink layer on the paper substrate. As to the other configurations, the configurations of the conventionally known various decorative papers used in the so-called thermosetting resin decorative sheets can be adopted optionally according to the application.

[Paper Substrate]

For example, as the paper substrate 1, a titanium paper containing a titanium pigment is used typically, however, other papers can be used as well. Examples thereof include a craft paper, a high-quality paper, or a Japanese paper. Moreover, the fibers of the paper substrate are in general a cellulose fiber. Additionally, a mixed paper using a resin fiber, a glass fiber, or the like in combination may be used as well. Moreover, a resin impregnation paper with the papers impregnated with a resin, or the like can be used. The grammage of the paper substrate is about 50 to 120 g/m².

[Pattern Ink Layer]

The pattern ink layer 2 can be formed using a known ink by a known forming method and material such as gravure printing, offset printing, flexo printing, ink jet printing, or the like. The pattern ink layer 2 in the present invention is a layer substantially not containing a pearl pigment, unlike the pearl ink layer 3, and it is a layer expressing a pattern with an ordinary ink. As to the resin of the binder for the pattern ink layer 2, known resins such as a casein resin, an acrylic resin, a cellulose based resin and an urethane resin can be used optionally according to the application. Moreover, as to the coloring agent, known coloring agents such as a red iron oxide, a chrome yellow and a phthalocyanine blue can be used optionally according to the application.

[Pearl Ink Layer]

The pearl ink layer 3 can be used by a known forming method and material such as gravure printing like the above-mentioned pattern ink layer, except that at least a pearl pigment is contained as the coloring agent and a pearl pigment peculiar to the present invention is used as the pearl pigment. The pearl ink layer may contain a conventionally known coloring agent. The pattern of the pearl ink layer and the above-mentioned pattern ink layer can be selected optionally including an entire solid in accordance with the application. As to the resin of the binder for the pearl ink layer, known resins such as a casein resin, an acrylic resin, a cellulose based resin and an urethane resin can be used optionally according to the application.

In this invention, as the pearl pigment for the pearl ink layer, a conventionally common pearl pigment with the scaly foil of mica merely covered with a titanium dioxide and/or an iron oxide is not used. In the invention, a pearl pigment with the surface covered by the titanium dioxide or the iron oxide and further treated with a zirconium oxide hydrate is used. Using the pearl pigment with the surface treated further with a zirconium oxide hydrate is considered to probably improve the affinity to the resin of the binder, and thereby improve the adhesion property to the resin. Therefore, at the time heat or stress is applied, peeling off of the pearl pigment and the binder resin can be restrained so that blisters can hardly be generated at the time of the postforming process. Moreover, crack generation brought about by forcibly lowering the process temperature to avoid generation of blisters can be prevented.

Here, FIGS. 2(A1) to 2(B2) are cross-sectional views for each conceptually explaining the situation of generating cracking “c” and blisters “b” at the time of the postforming process (or in a pearl-like thermosetting resin decorative sheet as a postformed product after the process). FIG. 2(A1) is a cross-sectional view showing the situation of generating cracking c in the portion with a pearl-like thermosetting resin decorative sheet 20 bent at the time of bending and attaching the decorative sheet 20 onto a substrate 7 with a round corner as the adherend 6 by the postforming process. Moreover, FIG. 2(A2) shows the situation of generating blisters “b” by the pearl pigment “p” dispersed and held in the binder resin “r” of the pearl ink layer at the time of heating the pearl-like thermosetting resin decorative sheet by the post forming process. On the other hand, FIG. 2(B1) is a cross-sectional view of the case with no crack generation, and FIG. 2(B2) shows the case with no blister generation.

A zirconium oxide hydrate is also referred to as a zirconium hydroxide. Such a specific pearl pigment used in the present invention is accessible for example as a product of Merck Ltd., (“Iriodin” (registered trademark) WII grade or W-NT grade). Moreover, the pearl pigment used in the present invention may have the surface treated with a zirconium oxide hydrate further covered with a known finishing agent such as an organic silane coupling agent for improvement of the physical properties such as the ink dispersion stability.

The size of the pearl pigment can be adjusted optionally according to the design. In general, the range of the particle size (the radius of the circumscribing sphere or the diagonal line length) is about 1 to 100 μm, in particular, about 5 to 40 μm. Moreover, the addition amount of the pearl pigment can also be adjusted according to the design. It is in general about 10 to 200% by mass to the resin.

[Other Layers]

The pearl-like decorative paper of the present invention may optionally have a layer other than the above-mentioned within a scope not departing from the gist of the present invention. For example, a primer layer, a sealer layer, or the like provided between the paper substrate and the pearl ink layer, or between the paper substrate and the pattern ink layer can be presented.

§ 3. Pearl-Like Thermosetting Resin Decorative Sheet:

Next, the pearl-like thermosetting resin decorative sheet having postforming suitability of the present invention will be explained. The pearl-like thermosetting resin decorative sheet of the present invention is characterized by the configuration using the pearl-like decorative paper as mentioned above for a decorative paper. For the other configurations, various configurations of the so-called thermosetting resin decorative sheets can be adopted optionally according to the application. For example, as the adherend 6, a backing substrate, an overlaying paper, or the like is common as shown in the thermosetting resin decorative sheet 20 of FIG. 1(B).

[Pearl-Like Decorative Paper]

The pearl-like decorative paper 10A in the pearl-like thermosetting resin decorative sheet is a layer impregnated with a thermosetting resin and cured as shown in FIG. 1(B). As the thermosetting resin for the impregnation, a known resin may be used according to the application. For example, a typical example is a melamine resin. Additionally, a guanamine resin, a phenol resin, an unsaturated polyester resin, and a diallyl phthalate (DAP) resin can be presented.

[Adherend: Backing Substrate]

The backing substrate 4 as the adherend 6 is a substrate to be laminated, adhered and integrated with the rear side of the decorative paper for providing desired shape, thickness, dynamic strength, and the postforming suitability or the like in the case of the postforming application to the thermosetting resin decorative sheet. As such a backing substrate 4, a core paper or the like is common for the postforming application in terms of the postforming suitability, or the like, as the thermosetting resin decorative sheet before the postforming process. Moreover, as the thermosetting resin decorative sheet after the postforming process, it has a configuration with another substrate such as a woody sheet further laminated as the backing substrate onto the rear side of the core paper or the like laminated. The core paper is a paper impregnated with an uncured thermosetting resin (representatively, a phenol resin, and additionally, the impregnation resins for the above-mentioned decorative paper, or the like).

That is, the pearl-like thermosetting resin decorative sheet having postforming suitability of the present invention is naturally suitable for the postforming application. In this case, both of the pearl-like thermosetting resin decorative sheets, of before and after the process, are included.

[Adherend: Another Substrate]

At the time of the postforming process, as a backing substrate which works as another substrate for the pearl-like thermosetting resin decorative sheet to attach after the process (or to be used in the case of not applying the postforming process), the postforming suitability for bending process of the decorative sheet needs not be taken into consideration. For example, a woody substrate, an inorganic substrate, a metal substrate, or the like can be used. As the woody substrate, there are a single panel, plywood, a particleboard, a fiber, a laminated wood, or the like. As the metal substrate, for example, there are metal sheets of iron, aluminum, or the like. These substrates are laminated in general via an adhesive.

[Adherend: Overlaying Paper]

As the overlaying paper 5, those conventionally known commonly, used for the thermosetting resin decorative sheets can be used. Representatively, a melamine paper resin impregnated paper with a transparent paper impregnated with a melamine resin can be used. As the impregnation resin for the overlaying paper 5, the impregnation resins for the above-mentioned pearl-like decorative paper, or the like can be presented.

[Thermal Pressure Molding]

The pearl-like thermosetting resin decorative sheet is manufactured by a known method. For example, the pearl-like thermosetting resin decorative sheet is produced by thermal pressure molding of curing the impregnation resin while applying heat and pressure to the impregnated decorative paper laminated with the other adherend such as a core paper or an overlaying paper, after producing an impregnated decorative paper by impregnating the above-mentioned pearl-like decorative paper with a thermosetting resin solution of a melamine resin, or the like. For the thermal pressure molding, the thermal pressure molding process in the various kinds of thermosetting resin decorative sheets such as a melamine decorative sheet can be adopted optionally. In the case of using an (uncured) adherend to be impregnated with the resin such as the backing substrate and the overlaying paper, it is in general cured simultaneously at the time of the thermal pressure molding.

[Applications]

The applications of the thermosetting resin decorative sheet (or consequently the applications of the decorative paper) are not particularly limited. For example, they are the top board or the sideboard of a desk, a table, counter, or the like, fittings for a door or the like, furniture, building interior materials such as a wall and a floor, interior materials for various kinds of vehicles such as an automobile, a train and a ship, and electric appliance cabinets for a television or the like.

Although the pearl-like decorative paper and the pearl-like thermosetting resin decorative sheet of the present invention are preferable for the postforming application, it is not limited to the application, and they can be used for the other applications.

### EXAMPLE 1

A pearl-like decorative paper 10 and a thermosetting resin decorative sheet 20 having postforming suitability as shown in the cross-sectional views of FIGS. 1(A) and 1(B) were produced. First, by forming a pattern ink layer 2 and a pearl ink layer 3 successively using the following pearl pigment by a gravure web press on a titanium paper of 80 g/m grammage containing 25% by mass of a titanium oxide as the paper substrate 1, a desired pearl-like decorative paper 10 was produced.

The above-mentioned pattern ink layer 2 was a layer formed by two color printing of a solid pattern using a quinacridone as the coloring agent and a solid pattern using an isoindolinone as the coloring agent. For the pearl pigment of the above-mentioned pearl ink layer 3, a pearl pigment comprising the scaly foil of mica covered with a titanium dioxide, and further the surface thereof treated with a zirconium oxide hydrate of the WII grade or W-NT grade (particle size distribution 10 to 40 μm, average particle size 17 μm), produced by Merck Ltd., was used.

Moreover, as the resin for the ink of the above-mentioned pattern ink layer 2, and the resin for the ink of the above-mentioned pearl ink layer 3, a resin mixture of an acrylic resin and a casein resin by a 1:9 mass ratio was used for both of them. Then, the content of the pearl pigment of the pearl ink layer was 150 parts by mass with respect to 100 pats by mass of the binder resin of the ink. Moreover, the thickness of each layer by the coating amount (after drying) of 4 g/m² in the pattern ink layer (for 2 colors), and 3 g/m² in the pearl ink layer.

Subsequently, in order to produce a pearl-like thermosetting resin decorative sheet, the above-mentioned pearl-like decorative paper impregnated with a melamine resin solution was placed on 4 core papers impregnated with a phenol resin as the backing substrate 4 (adherend 6). An overlaying paper 5 (adherend 6) comprising a transparent paper impregnated with amelamine resin (impregnation ratio 300%) was further placed thereon, and a thermal pressing molding was applied thereto so as to produce a desired pearl-like thermosetting resin decorative sheet 20 as shown in FIG. 1(B). The melamine resin impregnation with respect to the pearl-like decorative paper was of a 50% impregnation ratio. The impregnation ratio is a value obtained from a calculation formula of [(weight after the impregnation−weight before the impregnation)/weight after the impregnation]×100. Moreover, as to the conditions at the time of the thermal pressing molding, with a 9 to 10 MPa pressure (90 to 100 kgf/cm²), a heating operation was carried out by inserting the materials into a pressing machine at a room temperature (25° C.), raising the temperature after applying pressure, heating at 145° C. for 10 minutes, cooling down to the room temperature while applying the pressure, and releasing the pressure for taking out the molded product.

### COMPARATIVE EXAMPLE 1

In the same manner as in the example 1 except that the pearl pigment used for the pearl ink layer in the example 1 was changed to an ordinary pearl pigment comprising the scaly foil of mica covered with a titanium dioxide with the process of a zirconium oxide hydrate omitted, a pearl-like decorative paper and a thermosetting resin decorative sheet were produced.

[Performance Evaluation]

Evaluation of the postforming suitability with respect to the postforming process was carried out as follows. The temperature of the decorative sheet at the time of starting generation of blisters (swelling of the decorative sheet) with the above-mentioned pearl-like thermosetting resin decorative sheet heated by an infrared ray heater for heating and raising the temperature was evaluated. With a higher generation starting temperature, the process suitability was judged to be better. As a result, the generation starting temperature of the decorative sheet was 196° C. for the comparative example, whereas it rose higher, 204° C., for the decorative sheet of the example with only the pearl pigment changed so that the postforming suitability improving effect was confirmed. According to the evaluation method, since the resin of the ink was not changed for the example and the comparative example, the bending easiness by the resin was same, and thus the evaluation result difference can be contributed to the improving effect by the pearl pigment change.

### BRIEF DESCRIPTION OF THE DRAWINGS

FIGS. 1(A) to 1(B) are cross-sectional views each showing an example of one embodiment of a pearl-like decorative paper (A) and a pearl-like thermosetting resin decorative sheet (B) having postforming suitability according to the present invention.

FIGS. 2(A1) to 2(B2) are cross-sectional views for each explaining conceptually crack generation and blister generation, which may be generated at the time of the postforming process.

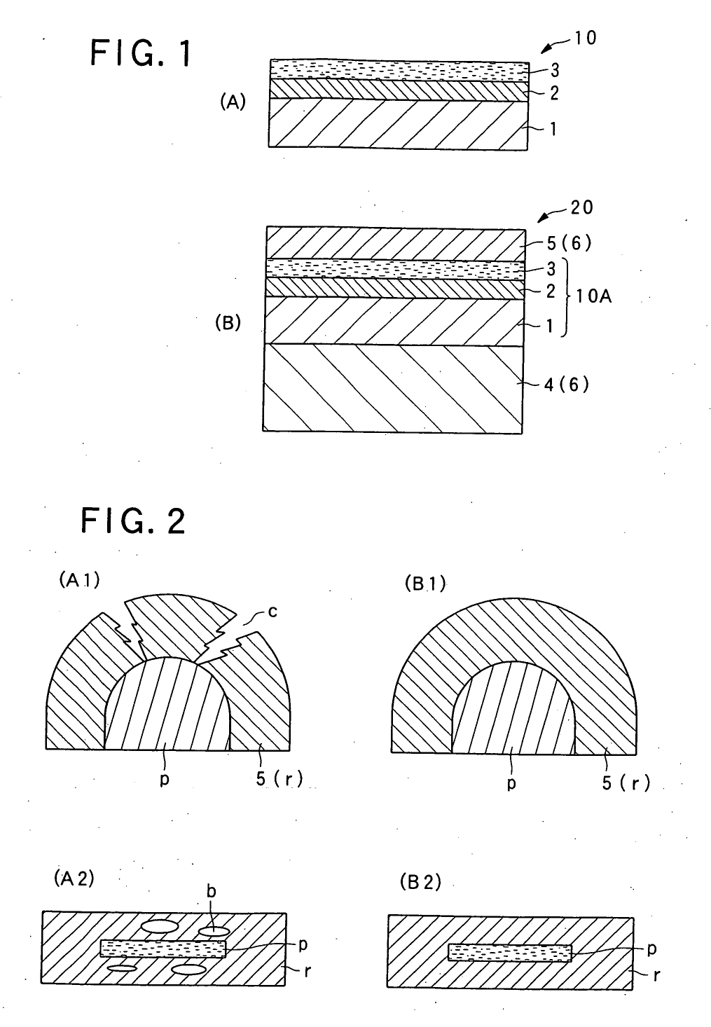

### EXPLANATION OF REFERENCES

1 paper substrate
2 pattern ink layer
3 pearl ink layer
4 backing substrate
5 overlaying paper
6 adherend
7 (another) substrate
10 pearl-like decorative paper
10A pearl-like decorative paper (resin impregnated and cured)
20 pearl-like thermosetting resin decorative sheet
b blister
c cracking
p pearl pigment
r binder resin

1. A pearl-like decorative paper having postforming suitability comprising a pearl ink layer which contains a pearl pigment on a paper substrate,
wherein the pearl pigment is a pearl pigment containing a scaly foil of mica covered with a titanium dioxide and/or an iron oxide, and a surface thereof is further treated with a zirconium oxide hydrate.

2. A pearl-like thermosetting resin decorative sheet having postforming suitability comprising a layer obtained by impregnating the pearl-like decorative paper according to claim 1 with a thermosetting resin and curing.
